(19) United States
(12) Patent Application Publication
(10) Pub. No.: US 2018/0297134 A1
(43) Pub. Date: Oct. 18, 2018

(54) DEBURRING DEVICE AND CNC GEAR-CUTTING MACHINE COMPRISING SUCH A DEBURRING DEVICE

(71) Applicant: Klingelnberg AG, Zurich (CH)

(72) Inventors: Ji Kyung Yoon, Karlsruhe (DE); Jürgen Weber, Hückeswagen (DE); Karl-Martin Ribbeck, Remscheid (DE)

(21) Appl. No.: 15/948,463

(22) Filed: Apr. 9, 2018

(30) Foreign Application Priority Data
Apr. 13, 2017 (DE) 102017107999.8

(51) Int. Cl. B23F 19/10

(52) U.S. Cl. CPC B23F 19/102

(57) ABSTRACT

A deburring device (50) for deburring bevel gears, having a first deburring spindle (51) for attaching a first deburring tool (60.1), wherein the first deburring spindle (51) is rotationally drivable by means of a drive about a first deburring spindle axis (Q1), wherein the deburring device (50) additionally comprises a second deburring spindle (52) for attaching a second deburring tool (60.2), wherein the second deburring spindle (52) is rotationally drivable by means of a drive about a second deburring spindle axis (Q2), and wherein the first deburring spindle axis (Q1) and the second deburring spindle axis (Q2) extend parallel to one another.

### CROSS-REFERENCE TO RELATED APPLICATIONS

This application claims the benefit under 35 U.S.C. § 119(e) to German Application no. DE 10 2017 107 999.8 filed Apr. 13, 2017, which is hereby expressly incorporated by reference as part of the present disclosure.

### FIELD OF THE DISCLOSURE

The present disclosure generally relates to a deburring device for deburring bevel gears and a CNC gear-cutting machine which is equipped with such a deburring device.

### BACKGROUND

In the manufacturing of bevel gears, a burr (also referred to as a primary burr here) can arise, for example, at the outer tooth end due to the cutting machining. Because of the high risk of injury, but also because of the risk of complete hardening when hardening the bevel gears, these tooth edges are frequently broken by a chamfer in the scope of chamfering.

In the described chamfering, depending on the constellation, a secondary burr can result on the bevel gear upon the removal of the primary burr. If the primary deburring is performed using a deburring tool, the cutting edge(s) of which are guided outward coming out of a tooth gap, the secondary burr thus results on the outer circumference of the bevel gear, as shown in FIG. 1A. In contrast, if the deburring tool is guided from the base F to the head K of the bevel gear 10 (into a tooth gap 14) during the primary deburring, the secondary burr thus results in the functional region of the bevel gear 10. In mass production, the primary deburring is therefore carried out in most cases from the inside to the outside, as symbolized in FIG. 1A by the block arrow P1.

A corresponding example is shown in FIG. 1A. A primary burr primarily occurs at the tooth edge 11.r of the concave flank 16.r, since this flank 16.r generally forms a relatively acute angle δ with the rear face 17 of the bevel gear tooth 10. If only the primary burr 20 were removed at this tooth edge 11.r (for example, by using a brush), a very sharp tooth edge 11.r would remain standing. Therefore, a chamfer is usually created at least in the region of the tooth edge 11.r by chamfering.

The situation after the chamfering of the tooth edge 11.r is shown in FIG. 1B on the basis of the bevel gear 10 of FIG. 1A. The profile of the first chamfer 12 can be schematically seen in FIG. 1B. As can also be seen in FIG. 1B, a secondary burr 21 can form along the first chamfer 12.

However, a secondary burr 21 does not always form. Relationships have been shown here, for example, consistent with the quality of the cutting edges of the deburring tool. As long as the deburring tool has sharp cutting edges, the primary deburring runs relatively reliably. As cutting edges become blunter, the material of the bevel gear is no longer cut, but rather, displaced. In this case, the tendency toward forming secondary burr increases. Since the tooth edge typically does not have a linear profile between bevel gear teeth and, for example, the base of the bevel gear, the thickness of the chips to be removed during the chamfering varies. For these reasons, secondary burrs can sometimes arise.

Secondary burrs can be removed, for example, by the use of nylon or brass brushes, but these tools are subject to wear, however. They therefore have to be replaced from time to time. To avoid the occurrence of secondary burrs, the cutting edges of the deburring tools could also be reground more often, which is linked to a time and cost expenditure, however, especially because one has to intervene early enough, before secondary burrs can begin to form at all.

There is a further aspect which plays an important role in bevel gear manufacturing. Because of economic boundary conditions, the bevel gear manufacturing—especially if it relates to mass production—is to be optimized in all its sequences, on the one hand, to use resources carefully and, on the other hand, to be able to machine as many bevel gears as possible per unit of time.

The deburring described at the outset is a partial process of bevel gear manufacturing. There also appears to be potential for further improvements of the sequences in this partial process.

Therefore, on the one hand, the need exists to chamfer bevel gears such that all burrs are removed reliably and safely. Especially in the mass production of bevel gears—for example, in automobile construction—the problems which result in conjunction with primary burrs and secondary burrs have to be avoided.

On the other hand, the need exists to make the deburring more efficient. This need applies not only in conjunction with the removal of primary burrs and/or secondary burrs, but rather applies in general for the entire deburring procedure.

Situations occur again and again above all in the case of bevel gears, in which a collision of a deburring tool with the teeth of a bevel gear would occur, if one did not intentionally avoid collisions by targeted movement of the deburring tool and the bevel gear. Complicated movements sometimes have to be executed in three-dimensional space to introduce the cutting edges of the deburring tool without collision into the tooth gaps of the bevel gear, to execute a deburring procedure therein, for example, from the inside to the outside.

### SUMMARY

It is therefore an object to provide a deburring device and a bevel gear gear-cutting machine comprising such a deburring device such that burrs can be removed reliably and as efficiently as possible with little effort on various types of bevel gears.

In one aspect, a deburring device for deburring bevel gears is provided, having a first deburring spindle for attaching a first deburring tool, wherein the first deburring spindle is rotationally drivable by means of a drive about a first deburring spindle axis. The deburring device also has a second deburring spindle for attaching a second deburring tool, wherein the second deburring spindle is rotationally drivable by means of a drive about a second deburring spindle axis. The first deburring spindle axis and the second deburring spindle axis extend parallel to one another.

At least one deburring cutter head is used as a deburring tool in some embodiments. The term “deburring tool” is used hereafter, interchangeably with the term “deburring cutter head,” if not explicitly indicated otherwise.

The deburring tool, which was already previously used during the removal of primary burrs, is set steeper before carrying out the second pass, to also be able to remove the secondary burrs on the same bevel gear. Alternatively, however, the respective other deburring tool can be used during the removal of the secondary burrs. This means that a different tool is used during the removal of the primary burrs than during the removal of the secondary burrs.

A deburring device having two deburring spindles may be used for removing the primary and secondary burrs in some embodiments.

A deburring device may be used in some embodiments that comprise a first deburring tool for the first pass and a second deburring tool for the second pass.

In some embodiments, the first deburring tool and the second deburring tool are seated coaxially on a common deburring axis.

A first deburring tool and a second deburring tool are used in some embodiments, wherein these two deburring tools are driven in solidarity by a common driveshaft.

Deburring cutter heads, which are equipped with cutter inserts (for example, in the form of bar cutters) made of hard metal are used in some embodiments. The use of hard metal cutter inserts offers degrees of freedom in the design of the cutting edges of these cutter inserts.

One advantage of embodiments disclosed herein is that a corresponding bevel gear gear-cutting machine is flexibly usable, and the removal of primary and secondary burrs takes place reliably and with uniform accuracy, wherein the one or the other deburring tool can be used as needed.

Some further advantages of embodiments disclosed herein are that, by using the axes (NC axes) numerically controllable by means of a programmable CNC controller, nearly arbitrarily shaped profile edges of bevel gears are achievable using the cutting edges of the two deburring tools. A double facet can thus be created even with a curved profile edge.

Another advantage of embodiments disclosed herein is that one has more degrees of freedom for optimizing the individual method sequences during the deburring and/or chamfering than in methods or devices which only comprise one deburring device. This means that fewer compromises have to be made in deburring and/or chamfering.

Another advantage of embodiments disclosed herein is that, for example, during the deburring on the heel, a different deburring tool can be used than during the deburring of the toe of a workpiece.

Certain embodiments disclosed herein may be implemented particularly advantageously in a six-axis, CNC-controlled bevel gear gear-cutting machine, which comprises a deburring device, to which at least one additional axis is allocated. The deburring device may be assigned at least one linear axis and one deburring spindle axis in some embodiments.

The deburring device can also be assigned one linear axis, one pivot axis, and one deburring spindle axis in some embodiments.

According to one aspect, a deburring device for deburring bevel gears has a first deburring spindle configured for attachment of a first deburring tool thereto. The first deburring spindle is rotationally drivable about a first deburring spindle axis. The deburring device further has a second deburring spindle configured for attachment of a second deburring tool thereto. The second deburring spindle is rotationally drivable by a drive about a second deburring spindle axis. The first deburring spindle axis and the second deburring spindle axis extend substantially parallel to one another. In some embodiments, the first deburring spindle axis and the second deburring spindle axis extend coaxially with one another. In some embodiments, a single or common drive drives the spindles.

In some embodiments, a central shaft is rotatably driven by the drive and a transmission converts the rotational movement of the central shaft into rotational movement of the first and second spindles. In some such embodiments, the central shaft includes a first bevel gear, the first deburring spindle includes a first spindle shaft that includes a second bevel gear, and the first and second bevel gears are part of the transmission. The first and second bevel gears intermesh and roll on one another such that the first deburring spindle axis intersects a rotational axis of the central shaft.

In some embodiments, the first deburring spindle axis has a first spindle shaft, and the second deburring spindle axis has a second spindle shaft mechanically connected to the first spindle shaft.

In some embodiments, the deburring device has a pivot axis enabling joint rotation of the first deburring spindle axis and the second deburring spindle axis about the pivot axis. In some embodiments, the pivot axis is substantially perpendicular to the first deburring spindle axis and the second deburring spindle axis. In some embodiments, the pivot axis is coaxial with the rotational axis of the central shaft.

In another aspect, a six-axis CNC gear-cutting machine has a first tool spindle adapted to hold and rotationally drive a gear-cutting tool, a second tool spindle adapted to hold and rotationally drive a workpiece, and a deburring device as described herein. In some embodiments, a single or common drive rotationally drives and jointly rotates the deburring tools. In some embodiments, the first and/or second deburring tools can deburr bevel gears with rotational and/or pivoting movement.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features will become apparent from the following detailed description, which are to be understood not to be limiting and which will be described in greater detail hereafter with reference to the drawings, wherein:

FIG. 1A shows a schematic perspective view of an exemplary bevel gear, wherein a single tooth gap is indicated after the gear-cutting, on the profile edge of which primary burrs have formed;

FIG. 1B shows a schematic perspective view of the bevel gear of FIG. 1A, after a first chamfer was created at the profile edge, wherein secondary burrs have formed at the newly resulting chamfer edge in the upper region;

FIG. 1C shows a schematic perspective view of an exemplary bevel gear, wherein a single tooth gap is indicated after the gear-cutting, on the profile edge of which primary burrs have formed;

FIG. 1D shows a schematic perspective view of the bevel gear of FIG. 1C, after a first chamfer was created at the profile edge, wherein secondary burrs have formed at the newly resulting chamfer edge in the upper region;

FIG. 1E shows a schematic perspective view of the bevel gear of FIG. 1C, after a second chamfer was created in the region of the first chamfer;

FIG. 2 shows a perspective partial view of an exemplary gear-cutting machine, which is equipped with a deburring device;

FIG. 3 shows a schematic view of an exemplary deburring device;

FIG. 4A shows a schematic perspective view of an exemplary deburring device;

FIG. 4B shows a schematic sectional view of the deburring device of FIG. 4A along line A-A.

### DETAILED DESCRIPTION

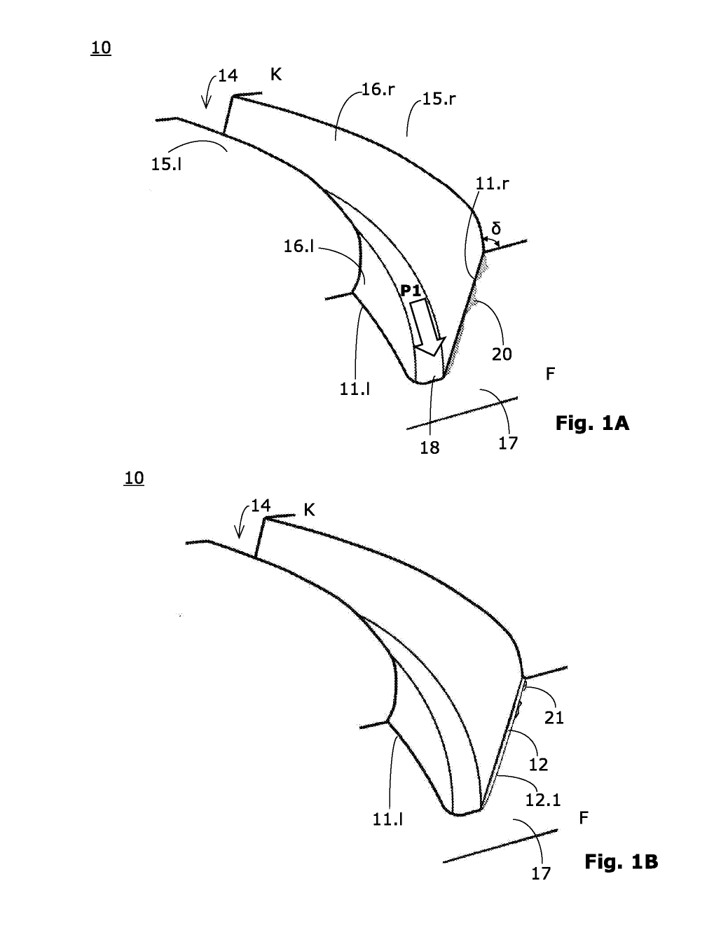

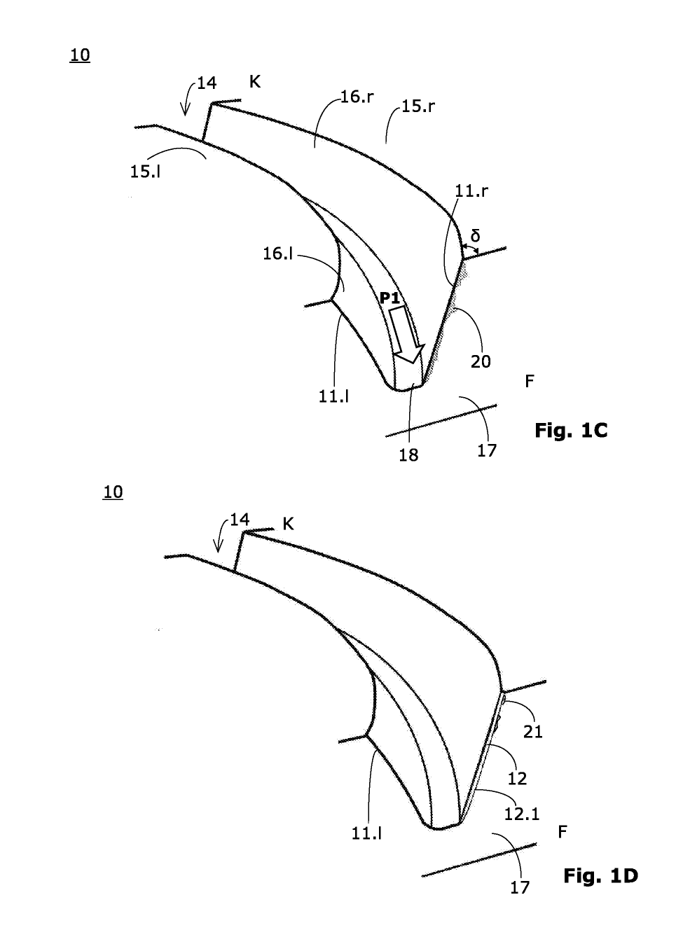

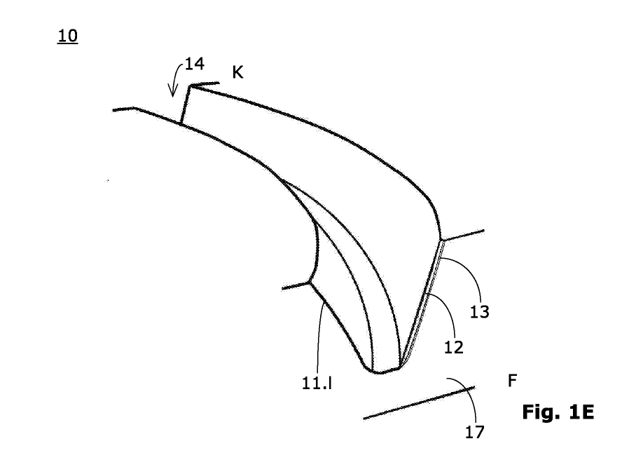

FIGS. 1C through 1E show a schematic perspective view of a bevel gear 10, wherein exemplary steps of a process are explained, which can be executed using a deburring device 50. The elements and terms which are used herein are defined on the basis of FIGS. 1C through 1E.

In FIGS. 1C through 1E, only a part of the main body of a bevel gear pinion 10 can be seen in schematic form. A single tooth gap 14 is indicated in the material of the main body. The example shown is a bevel gear 10 having a curved flank longitudinal line, as can be seen from the profile of the teeth 15.r and 15.l. However, the disclosure herein may also be applied to other bevel gears 10.

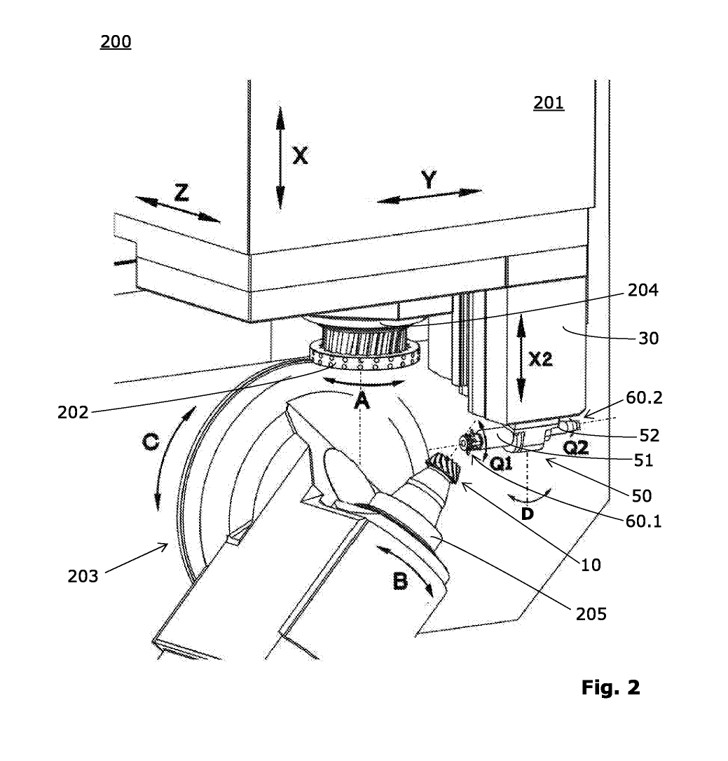

The bevel gear pinion 10 has a main body in the example shown, which is defined by two truncated cones having corresponding cone lateral surfaces. These cone lateral surfaces, to be precise, are truncated cone lateral surfaces. The two truncated cones are arranged coaxially to the workpiece spindle axis B. The workpiece spindle axis B can be seen in FIG. 2.

The teeth 15.r. and 15.l of the bevel gear pinion 10 extend along the head truncated cone lateral surface. The truncated cone lateral surface 17 in FIGS. 1C through 1E is generally referred to here as a (ring-shaped) heel-side lateral surface 17. In bevel gears, the terms cone wheel head or simply head K and cone wheel base or base F are also used. The head K of the bevel gear 10 is located in FIGS. 1C through 1E on the left side and the base F is located on the side of the truncated cone lateral surface 17.

In the transition region from the teeth 15.r. and 15.l to the truncated cone lateral surface 17, primary burrs 20 can arise during the cutting machining (referred to here as gear-cutting or gear-cutting machining) (see FIG. 1C). In the transition region of the concave tooth flank 16.r to the truncated cone lateral surface 17, a right tooth edge 11.r (also called the right profile edge) results during the gear-cutting and in the transition region of the convex tooth flank 16.l to the truncated cone lateral surface 17, a left tooth edge 11.l (also called the left profile edge) results during the gear-cutting.

The primary burrs 20 form at the concave tooth flanks 16.r, or in the transition region of the concave tooth flanks 16.r to the truncated cone lateral surface 17. However, it is to be noted that primary burrs 20 can occur both at the tooth flanks and also at the root 18.

A primary burr 20 usually arises in the mentioned regions if milling is performed from the inside to the outside during the gear-cutting, i.e., if a tool, coming from the head K to the base F through the tooth gap 14, exits from this tooth gap 14 in the region of the truncated cone lateral surface 17. In FIG. 1C, a block arrow P1 is shown in the tooth gap 14, which indicates the cutting direction of a gear-cutting tool during the exit from this tooth gap 14.

To now be able to remove the primary burrs 20, the bevel gear 10 is chamfered in a bevel gear gear-cutting machine 200 (see, for example, FIG. 2). The chamfering comprises, for example, two passes. During a first pass, first chamfers 12 are formed at the tooth edges 11.r and/or 11.l. in a continuous procedure by the use of a first deburring tool 60.1, as shown by way of example and schematically in FIG. 1D. A continuous procedure is a procedure in which the bevel gear 10 and the first deburring tool 60.1 rotate while coupled in engagement with one another. The bevel gear 10 rotates in this case about the workpiece spindle axis B and the deburring tool 60.1 rotates about the deburring spindle axis Q1. During a second pass, for example, by using a second deburring tool 60.2, second chamfers 13 are formed in the region of the first chamfers 12 in a continuous procedure, as indicated by way of example and schematically in FIG. 1E. Before the second pass begins, the deburring device 50 can execute, for example, a rotational movement about the axis D and/or a linear displacement of the X2 axis.

To create a second chamfer 13 along the resulting chamfer edge 12.l (see FIG. 1E) in the second pass, the deburring tool 60.2 is set steeper in relation to the tooth edges to be deburred of the bevel gear 10 in the scope of the second pass, for example, than in the scope of the first pass.

FIG. 2 shows a perspective illustration of the basic structure of a first CNC gear-cutting machine 200 according to one embodiment, for producing and chamfering spiral-toothed bevel gears 10. Such a machine 200 is designed or refitted so that deburring or chamfering of the bevel gear 10 can be performed by means of the special deburring device 50, which comprises two deburring tools 60.1, 60.2.

The principles disclosed herein may also be applied to other CNC gear-cutting machines 200, however, which are equipped with the deburring device 50.

The CNC gear-cutting machine 200 can be constructed as follows. The machine 200 can comprise a machine housing 201, which enables a tool spindle 204 to be guided linearly vertical along a coordinate axis X (first axis), linearly horizontal along a coordinate axis Y (second axis), and linearly horizontal along a coordinate axis Z (third axis). The mentioned tool spindle 204 can be arranged hanging on the machine 200, for example, wherein the corresponding tool spindle axis A (fourth axis) hangs vertically in space. The tool spindle 204 bears a tool, a cutter head 202 having multiple bar cutters (the bar cutters are not visible) by way of example here.

A first pivot device 203 can be provided on the machine 200, for example, which bears a workpiece spindle 205 having a workpiece spindle axis B (fifth axis). The workpiece spindle 205 including workpiece spindle axis B can be pivoted about a pivot axis (C axis; sixth axis) of the first pivot device 203. The pivot axis C is perpendicular to the tool spindle axis A and extends horizontally in space here. If one looks from the front in the direction of the pivot axis C at the machine 200 of FIG. 2, the workpiece spindle 205 stands diagonally in an approximately two o'clock position at the moment shown. In this position, for example, a first deburring tool 60.1 of the deburring device 50 can interact with the bevel gear workpiece 10.

The workpiece spindle 205 bears a spiral-toothed bevel gear pinion as the workpiece 10 in the example shown. The first pivot device 203 is pivotable about the C axis such that the workpiece 10 is pivotable into a machining position below the gear-cutting tool 202. Moreover, the workpiece 10 can be transferred into the position shown in FIG. 2 by the first pivot device 203 for deburring.

In addition, the deburring device 50 has, for example, infeed device(s), to move the deburring tool 60.1 or the deburring tool 60.2 in relation to the bevel gear workpiece 10 and be able to bring them into interaction therewith.

The infeed device can comprise in some embodiments, for example, a pivot axis D (in a hanging constellation here) and/or a linear axis X2, as shown by way of example in FIG. 2.

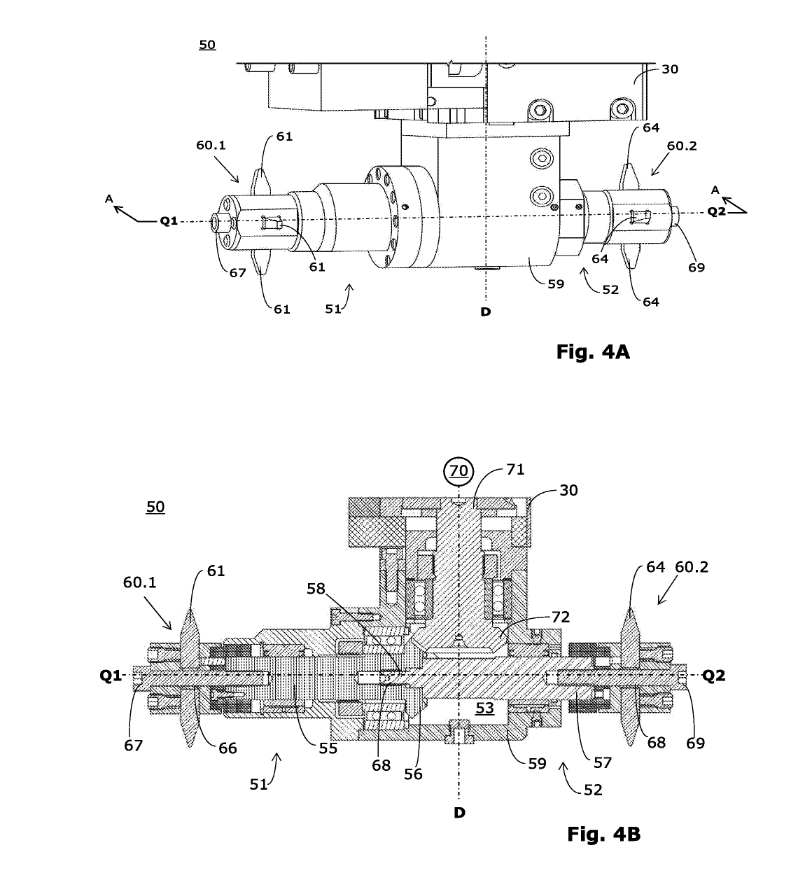

The pivot axis D can be coincident in at least some embodiments with the rotational axis of a central shaft 71, as shown in FIG. 4B.

The deburring device 50, comprising a deburring cutter head 60.1 and a deburring cutter head 60.2, can further comprise, for example, a linear axis X2 (seventh axis) and deburring spindle axes Q1 (eighth axis) and Q2 (ninth axis) as shown in FIG. 2.

The two deburring spindle axes Q1 and Q2 are coaxial to one another in some embodiments. However, embodiments are also possible in which the two deburring spindle axes Q1 and Q2 extend parallel to one another, but have a slight spatial offset to one another.

The deburring spindle axes Q1 (eight axis) and Q2 (ninth axis) may be driven in opposite directions in some embodiments.

Using one or more of the mentioned axes, the deburring tool 60.1 or 60.2 can be moved into a starting position suitable for the deburring in relation to the bevel gear workpiece 10.

The workpiece 10 is then rotationally driven about the workpiece spindle axis B and the deburring tool 60.1 and/or 60.2 is/are rotationally driven about the deburring spindle axis Q1 or Q2 and they are moved in relation to one another. In a continuous method, the cutting edges of the deburring tool 60.1 or 60.2 (for example, the cutting edges of the deburring cutters 61 of the deburring cutter head 60.1 or the deburring cutter head 60.2) execute corresponding chamfering movements at the predetermined edges 11.r and/or 11.l of the bevel gear 10. In the scope of this procedure, which is referred to as the first pass, the first chamfers 12 are created. The result of this first pass is shown by way of example in FIG. 1D, a first chamfer 12 only having been generated at the right edge 11.r here.

In the scope of a second pass, which is carried out in some embodiments on the same machine 200, a second chamfer 13 is created in the region of the first chamfer 12. This takes place either using the same deburring tool 60.1 or using another (second) deburring cutter head 60.2. The result of this second pass is shown by way of example in FIG. 1E, wherein a second chamfer 13 was also only created here in the region of the previous right edge 11.r.

As already mentioned, a different deburring tool can be used during the second pass than during the first pass. In the first pass, for example, a deburring tool 60.1 can be used and in the second pass, for example, a deburring tool 60.2 can be used. However, it is also possible in some embodiments to use the deburring tool 60.2 in the first pass, for example, and to use the deburring tool 60.1 in the second pass, for example.

To alternatively (as needed) be able to use either the first deburring tool 60.1 or the second deburring tool 60.2, the machine 200, or the deburring device 50, respectively, can have a pivot axis D, as shown in FIGS. 2, 4A, and 4B. This pivot axis D can be arranged vertically hanging, for example, as can be seen in FIGS. 2, 4A, and 4B.

The pivot axis D can also have a different orientation in space in some embodiments, however. The specific arrangement of the optional pivot axis D is dependent on the overall configuration of all axes of the machine 200, since it is important to move the workpiece 10 and the presently used deburring tool 60.1 or 60.2 in relation to one another such that a suitable deburring movement can be executed.

To be able to implement the chamfering/deburring in the continuous method, bevel gear gear-cutting machines 200 may have at least six numerically controlled axes, as shown by way of example in FIG. 2.

However, other CNC bevel gear gear-cutting machines 200 can also be refitted or equipped with seven, eight, or nine numerically controlled axes, as already explained on the basis of FIG. 2.

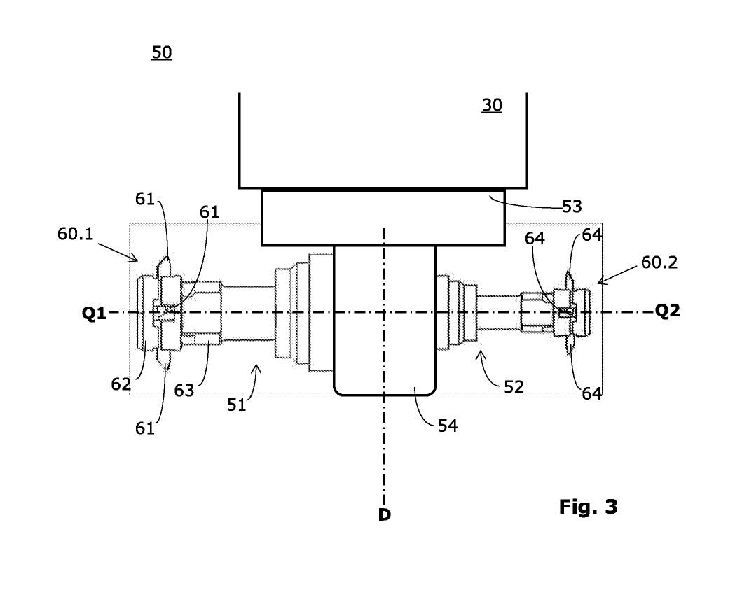

A further deburring device 50 will be described hereafter. The deburring device 50 shown in FIG. 3 can be used, for example, in a bevel gear gear-cutting machine 200 according to FIG. 2.

A carriage 30 having a deburring device 50 is provided on a machine stand and/or on a housing (for example, on the housing 201 of the machine 200). The carriage 30 enables a linear displacement of the deburring device 50 in relation to the bevel gear 10. The corresponding linear axis is referred to here as the X2 axis and extends parallel to the X axis, for example (see FIG. 2).

The deburring device 50 comprises in some embodiments a first deburring spindle 51 having the above-mentioned deburring spindle axis Q1, which has a horizontal orientation here in the example shown. A deburring tool can be fastened on the deburring spindle 51, which is referred to as the first deburring tool 60.1, as shown in FIG. 3. The first deburring tool 60.1 shown in FIG. 3 is specifically a deburring cutter head 60.1, which is equipped with cutter inserts (for example, in the form of bar cutters 61), such that they protrude radially beyond the circumference of the deburring tool 60.1.

The two axes X2 and D, which are associated with the deburring device 50, are in the illustrated embodiment CNC-controlled auxiliary axes. A bevel gear gear-cutting machine 200 comprising a deburring device 50 can therefore have a total of eight numerically controlled axes A, B, C, X, Y, Z, X2, and Q1/Q2. In the constellation shown in FIG. 2, the machine 200 has a total of 9 numerically controlled axes A, B, C, X, Y, Z, X2, Q1/Q2, and D, wherein the D axis is a pivot axis of the deburring device 50.

Numerically controlled axes are in this context are axes which may be activated via a programmable controller. The numerically controlled axes are designed and arranged such that by adjusting at least one of the axes, the workpiece spindle 205 including the bevel gear 10 is movable in relation to the deburring tool 60.1 or 60.2 such that cutting edges of the deburring tool 60.1 or 60.2, with simultaneous coupled rotation of the workpiece spindle 205 about the workpiece spindle axis B and the deburring tool 60.1 about the deburring spindle axis Q1 or Q2, plunge in succession into tooth intermediate spaces 14 of adjacent teeth 15.r, 15.l of the bevel gear 10 and execute a chamfering or deburring movement with respect to the predefined tooth edges 11.r, 11.l and chamfer edges 12.l of the bevel gear 10.

As indicated in FIG. 2, the deburring spindle axis Q1/Q2 of the deburring device 50 can extend, for example, parallel to the Y axis. However, other axis constellations are possible.

One or more of the numerically controlled axes are used in some embodiments to move the cutting edges of the deburring tool 60.1 or 60.2 in relation to the workpiece 10. Before carrying out the second pass of the method, the machine setting of the bevel gear gear-cutting machine 200 is changed such that, for example, the cutting edges of the second deburring tool 60.2 are steeper in relation to the affected edges of the workpiece 10 than in the scope of the first pass.

Since the bevel gear workpiece 10 rotates at a predefined first angular velocity about the workpiece axis B and the deburring tool 60.1 rotates at a second angular velocity about the deburring spindle axis Q1, and since the two rotational movements are performed (electronically) coupled, complex helical flight paths in three-dimensional space result for the cutter inserts 61 of the deburring tool 60.1.

The second deburring tool 60.2 accordingly also defines a complex helical flight path in three-dimensional space in the second pass.

The deburring device 50 of FIG. 3 comprises the two deburring spindles 51, 52 and the two deburring tools 60.1 and 60.2. The two deburring spindles 51, 52 and the two deburring tools 60.1 and 60.2 fastened thereon are arranged coaxially in the embodiment shown. The deburring tool 60.1 can be rotationally driven about the deburring spindle axis Q1 and the deburring tool 60.2 can be rotationally driven about the deburring spindle axis Q2.

In the pivot position of the deburring device 50 shown in FIG. 2, the deburring tool 60.1 can be brought into contact with the bevel gear 10 to carry out the first deburring or chamfering procedure. To be able to bring the second deburring tool 60.2 into contact with the bevel gear 10, the deburring device 50 is pivoted about the vertical axis D.

The bevel gear gear-cutting machine 200 of FIG. 2 can also be equipped, for example, with a deburring device 50, as shown by way of example in detail in FIGS. 4A and 4B.

A lower region of the carriage 30 can be seen in FIG. 3. A pivot device 53 and a drive unit 54, which can be pivoted in relation to the pivot device 53 about the vertical axis D, is seated here below the carriage 30. In the first position shown in FIG. 3, the first deburring tool 60.1 including first deburring spindle 51 points to the left and the second deburring tool 60.2 including second deburring spindle 52 points to the right.

It can be seen well in FIG. 3 that the two deburring spindles 51, 52 and the two deburring tools 60.1 and 60.2 fastened thereon are arranged coaxially. The deburring spindle axes Q1 and Q2 form a common axis. The rotational movement of the first deburring tool 60.1 including the first deburring spindle and the second deburring tool 60.2 including the second deburring spindle 52 can be coupled to one another (for example, by only providing one rotational drive in the drive unit 54). However, the drive unit 54 can also comprise two separate rotational drives.

Each deburring cutter head 60.1, 60.2 can be constructed according to the following principle, wherein the following specifications are merely to be understood as an example. This principle will be explained on the basis of the deburring cutter head 60.1 shown on the left in FIG. 3.

The example of a suitable deburring miller can be inferred from granted European patent EP1598137 B1.

The deburring cutter head 62.1 can be screwed onto the deburring spindle 51 via a plate 62 and screws (not shown). A main holder 63 is provided, which has various elements for accommodating the cutter inserts 61 (for example, in the form of bar-shaped deburring cutters). Three cutter inserts 61 are visible in FIG. 3. The deburring cutter head 60.1 can have multiple cutter inserts 61, which are insertable into recesses of the deburring cutter head 60.1, wherein the cutter inserts 61 are oriented substantially radially in relation to the deburring spindle axis Q1. Each of the cutter inserts 61 has at least one cutting edge for chamfering and/or deburring the workpiece 10. Instead of the recesses on the deburring cutter head 60.1, other fastening means can also be provided for clamping or fastening the cutter inserts 61.

In some embodiments, the deburring cutter head 60.2 can be constructed similarly or exactly as the deburring cutter head 60.1. It can be seen in FIG. 3 that the second deburring cutter head 60.2 is smaller in some embodiments than the first deburring cutter head 60.1. This is because, on the one hand, the cutting edges of the cutter inserts 64 of the second deburring cutter head 60.2 cut shorter second chamfers 13 than the cutting edges of the cutter inserts 61 of the first deburring cutter head 60.1. In addition, the second deburring cutter head 60.2 is set steeper to be able to cut the second chamfers 13. To avoid a collision with the workpiece 10, the second deburring cutter head 60.2 therefore protrudes less than the first deburring cutter head 60.1.

In some embodiments, cutter inserts 61, 64 may be made of hard metal, steel, or cutting ceramic. This is a substantial difference from conventional deburring millers. In one embodiment, micro-grain hard metal is used, because then the cutting edges of the cutter inserts 61, 64 remain sharp for a long time and cut cleanly.

FIG. 4A shows, and FIG. 4B shows a section through, a further deburring device 50. In this embodiment, the CNC-controlled drive 70 is seated above a central shaft 71. This central shaft 71 comprises a bevel gear 72 at the lowermost end. The shaft 71 is rotatably mounted in the housing 30. It can be seen on the left in FIG. 4B that a spindle shaft 55 extending perpendicularly to the shaft 71 is provided as the first output. A bevel gear 56 is provided on the spindle shaft 55 at the right end, which forms a bevel gear pair together with the bevel gear 72. This bevel gear pair can specify a suitable step-down or step-up transmission ratio as needed for rotationally driving the first deburring tool 60.1. The two bevel gears 56 and 72 form an angled transmission without axial offset here, i.e., the two axes Q1 and D intersect, as shown in FIG. 4B.

A deburring tool 60.1 is provided at the left end of the spindle shaft 55, which has multiple cutter inserts 61 having cutting edges on the outer circumference. The deburring tool 60.1 has a central borehole 66 here, through which a fastening screw 67 is screwed into the spindle shaft 55.

A further central borehole 68 is provided on the spindle shaft 55 in the region of the bevel gear 56. A second spindle shaft 57 is screwed using a pin-shaped extension 58 having external thread into this central borehole 68. The two spindle shafts 55 and 57 are rotationally driven in solidarity by the shaft 71 by way of this type of the connection.

A deburring tool 60.2 is provided at the right end of the spindle shaft 57, which has multiple cutter inserts 64 having cutting edges on the outer circumference. The deburring tool 60.2 has a central borehole 68 here, through which a fastening screw 69 is screwed into the spindle shaft 57.

Instead of equipping both deburring spindles 60.1, 60.2 with the same deburring tool (as shown in FIGS. 3, 4A, and 4B), each of the deburring spindles 60.1, 60.2 can also comprise a different deburring tool.

The first deburring spindle can comprise, for example, a deburring cutter head 60.1 having cutter inserts 61, while the second deburring spindle comprises a solid tool, for example, or vice versa.

The deburring device 50 can comprise an oil sump, for example, which is terminated by a lower lid or housing 59.

The first deburring tool 60.1 and the second deburring tool 60.2 are rotationally driven in solidarity in some embodiments by a common drive 70 (see FIG. 4B). If the central shaft 71 is driven clockwise by the drive 70, the spindle shaft 55 then also rotates clockwise. In contrast, the spindle shaft 57 rotates in the reverse rotational direction.

No noticeable time losses result for the deburring on the gear-cutting machine in two passes, since due to the use of two deburring tools 60.1, 60.2, it is possible to work in the continuous method at relatively high cutting speeds and because if needed, one, the other, or alternately both deburring tools 60.1, 60.2 can be used.

The applicant reserves the right to incorporate features from the description and the patent claims, which includes parts of sentences from the description and the claims, in a claim and, in particular, to make them the subject matter of a new patent claim.

Terms like substantially, preferably and the like and indications that may possibly be understood to be inexact are to be understood to mean that a deviation from the normal value is possible.

Unless stated otherwise, terms such as, for example, “comprises,” “has,” “includes,” and all forms thereof, are considered open-ended, so as not to preclude additional elements and/or features.

Also unless stated otherwise, terms such as, for example, “a” and “one” are considered open-ended, and do not mean “only a” and “only one”, respectively.

Also, unless stated otherwise, the phrase “a first” does not, by itself, require that there also be a “second.”

Also unless stated otherwise, terms such as, for example, “in response to” and “based on” mean “in response at least to” and “based at least on,” respectively, so as not to preclude being responsive to and/or based on, more than one thing.

While the above describes certain embodiments, those skilled in the art should understand that the foregoing description is not intended to limit the spirit or scope of the invention. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A deburring device for deburring bevel gears, comprising
a first deburring spindle configured for attachment of a first deburring tool thereto, wherein the first deburring spindle is rotationally drivable by a drive about a first deburring spindle axis, and
a second deburring spindle configured for attachment of a second deburring tool thereto, wherein the second deburring spindle is rotationally drivable by a drive about a second deburring spindle axis,
wherein the first deburring spindle axis and the second deburring spindle axis extend substantially parallel to one another.

2. The deburring device according to claim 1, wherein the first deburring spindle axis and the second deburring spindle axis extend coaxially with one another.

3. The deburring device according to claim 1, wherein a single drive defines the drive for rotationally driving the first deburring spindle and the drive for rotationally driving the second deburring spindle and is adapted to rotationally drive the first deburring spindle about the first deburring spindle axis and the second deburring spindle about the second deburring spindle axis.

4. The deburring device according to claim 3, further including a transmission adapted to convert rotational movement of a central shaft rotatably driven by the single drive into a rotational movement of the first deburring spindle about the first deburring spindle axis and of the second deburring spindle about the second deburring spindle axis.

5. The deburring device according to claim 4, wherein the first deburring spindle includes a first spindle shaft, the transmission includes a first bevel gear and a second bevel gear, the central shaft defines a rotational axis and the first bevel gear, the first spindle shaft defines the second bevel gear, and the first and second bevel gears are adapted to intermesh and roll on one another such that the first deburring spindle axis intersects the rotational axis of the central shaft.

6. The deburring device according to claim 4, wherein the first deburring spindle comprises a first spindle shaft, and the second deburring spindle comprises a second spindle shaft mechanically connected to the first spindle shaft.

7. The deburring device according to claim 1, further comprising a pivot axis configured to enable joint rotation of the first deburring spindle and the second deburring spindle about the pivot axis.

8. The deburring device according to claim 7, wherein the pivot axis is substantially perpendicular to the first deburring spindle axis and the second deburring spindle axis.

9. The deburring device according to claim 7, wherein the pivot axis is coaxial with a rotational axis of a central shaft configured to rotatably drive the first deburring spindle and of the second deburring spindle.

10. A CNC gear-cutting machine comprising:
a first tool spindle adapted to hold and rotationally drive a gear-cutting tool;
a second tool spindle adapted to hold and rotationally drive a workpiece; and
a deburring device adapted to deburr bevel gears comprising
a first deburring spindle configured for attachment of a first deburring tool thereto, wherein the first deburring spindle is rotationally drivable by a drive about a first deburring spindle axis; and
a second deburring spindle configured for attachment of a second deburring tool thereto, wherein the second deburring spindle is rotationally drivable by a drive about a second deburring spindle axis;
wherein the first deburring spindle axis and the second deburring spindle axis extend substantially parallel to one another;
wherein the CNC gear-cutting machine defines at least six axes.

11. The CNC gear-cutting machine according to claim 10, wherein a single drive defines the drive for rotationally driving the first deburring tool and the drive for rotationally driving the second deburring tool and is configured to jointly rotate the first deburring tool and the second deburring tool.

12. The CNC gear-cutting machine according to claim 10, wherein the CNC gear-cutting machine is adapted to deburr bevel gears using the first deburring tool or the second deburring tool for deburring bevel gears with a rotational or a pivoting movement.

13. The CNC gear-cutting machine according to claim 10, wherein the first deburring spindle axis and the second deburring spindle axis extend coaxially with one another.

14. The CNC gear-cutting machine according to claim 11, wherein a single drive defines the drive for rotationally driving the first deburring spindle and the drive for rotationally driving the second deburring spindle, and is adapted to rotationally drive the first deburring spindle about the first deburring spindle axis and the second deburring spindle about the second deburring spindle axis.

15. The CNC gear-cutting machine according to claim 11, further including a transmission adapted to convert rotational movement of a central shaft rotatably driven by the single drive into a rotational movement of the first deburring spindle about the first deburring spindle axis and of the second deburring spindle about the second deburring spindle axis.
